(19) United States
(12) Patent Application Publication
(10) Pub. No.: US 2023/0086339 A1
(43) Pub. Date: Mar. 23, 2023

(54) BRAZING METHOD AND METAL FILM FORMING TOOL FOR BRAZING

(71) Applicant: HONDA MOTOR CO., LTD., Tokyo (JP)

(72) Inventor: Takeshi Kiyama, Wako-shi (JP)

(21) Appl. No.: 17/942,203

(22) Filed: Sep. 12, 2022

(30) Foreign Application Priority Data
Sep. 22, 2021 (JP) 2021-153797
Sep. 22, 2021 (JP) 2021-153804

(51) Int. Cl. B23K 3/06; B23K 1/00; B23K 35/30

(52) U.S. Cl. CPC B23K 3/0607; B23K 1/0012; B23K 35/3033; B23K 2101/14

(57) ABSTRACT

In a film formation step of a brazing method, a metal brush formed by bundling a plurality of metal wires is brought into contact with a film formation target portion of a workpiece. Here, the film formation target portion is a portion that includes a joining target portion and a brazing-material-allowed portion but does not include an avoidance portion. In this state, the film formation target portion and the metal brush are relatively moved to each other. Thus, the metal film is formed on the film formation target portion. In a brazing step, the joining target portions are joined in a state where a brazing material is arranged on the joining target portion and the brazing-material-allowed portion.

### CROSS-REFERENCE TO RELATED APPLICATIONS

This application is based upon and claims the benefit of priority from Japanese Patent Applications No. 2021-153797 filed on Sep. 22, 2021 and No. 2021-153804 filed on Sep. 22, 2021, the contents all of which are incorporated herein by reference.

### BACKGROUND OF THE INVENTION

### Field of the Invention

The invention relates to a brazing method and to a tool for forming a metal film for brazing.

### Description of the Related Art

In a brazing method for brazing a pair of joining target portions (portions to be joined) included in a pair of workpieces, to each other, it is known to form a metal film on each of the joining target portions before brazing. One of the purposes of forming the metal film is to enhance the wettability of the joining target portions with respect to a brazing material. Thereby, for example, the joining quality of the joint such as joint strength and durability is improved. This type of metal film can be formed by performing electroplating (wet plating) on the joining target portion, as disclosed in, for example, JP H10-183363 A.

The workpiece may have a portion where the formation of a metal film is not allowed. Hereinafter, this portion is referred to as an avoidance portion. In the workpiece disclosed in JP H10-183363 A, a plurality of cooling holes are formed in the avoidance portion in order to allow cooling air to flow therethrough. For performing electroplating on such a workpiece, it is necessary to perform, as a pretreatment, a masking step of masking the avoidance portion with a masking material. In addition, it is necessary to perform a masking material removal step of removing the masking material from the avoidance portion, as a post-treatment after the electroplating has been performed.

### SUMMARY OF THE INVENTION

For example, as the shape of the avoidance portion becomes more complicated and more delicate, it becomes more difficult to mask the avoidance portion with the masking material in the masking step. Further, as the shape of the avoidance portion becomes more complicated and more delicate, in the masking material removal step, it becomes more difficult to remove the masking material without the masking material being left on the avoidance portion. Therefore, in the brazing method requiring the masking step and the masking material removal step, for example, there are concerns about the following issues. It takes a long time to complete the brazing. The cost of brazing is high. The process for completing brazing is complicated. That is, when the metal film is provided on the joining target portion to thereby improve the joining quality of the joint, there is a concern that it becomes difficult to efficiently and easily perform brazing.

An object of the present invention is to solve the above-described problems.

According to an aspect of the present invention, there is provided a brazing method for forming a metal film on at least one of a pair of joining target portions included in a pair of workpieces and thereafter brazing the pair of joining target portions to each other, wherein, of the pair of workpieces, a workpiece on which the metal film is to be formed includes a brazing-material-allowed portion adjacent to one joining target portion of the pair of joining target portions, and an avoidance portion on which formation of the metal film is not allowed, the brazing method including: a film formation step of forming the metal film on a film formation target portion by moving a metal brush relative to the film formation target portion with the metal brush being in contact with the film formation target portion, wherein the film formation target portion includes the one joining target portion and the brazing-material-allowed portion but does not include the avoidance portion, and the metal brush is formed by bundling a plurality of metal wires including a material for the metal film; and a brazing step of applying a brazing material to at least one of the pair of joining target portions and performing heat treatment on the pair of joining target portions between which the brazing material is provided, thereby joining the pair of joining target portions in a state where the brazing material is disposed on the pair of joining target portions and the brazing-material-allowed portion.

In this brazing method, the metal brush brought into contact with the film formation target portion is relatively moved with respect to the film formation target portion. Thus, the metal film can be formed on the film formation target portion. Therefore, for example, unlike a case where a metal film is formed by electroplating, a step of masking the avoidance portion is not necessary. As a result, it is possible to improve the joining quality of the joint by providing the metal film on the joining target portion and also to efficiently and easily perform brazing.

According to another aspect of the present invention, there is provided a metal film forming tool for brazing, for forming a metal film on at least one of a pair of joining target portions included in a pair of workpieces, before brazing the joining target portions to each other, the metal film forming tool for brazing including: a metal brush configured to form the metal film on the joining target portion by moving relative to the joining target portion in a state of being in contact with the joining target portion; and a support portion configured to support the metal brush, wherein the metal brush has a brush shape formed by bundling a plurality of metal wires, and each of the plurality of metal wires has a diameter of 0.1 to 0.6 mm.

In the metal film forming tool for brazing, the metal brush brought into contact with the film formation target portion is relatively moved with respect to the film formation target portion. Thus, the metal film can be formed on the film formation target portion. Therefore, for example, unlike a case where a metal film is formed by electroplating, a step of masking the avoidance portion is not necessary. As a result, it is possible to improve the joining quality of the joint by providing the metal film on the joining target portion and also to efficiently and easily perform brazing.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic exploded perspective view of a heat exchanger to which a brazing method using a metal film forming tool for brazing according to an embodiment of the present invention can be applied;

FIG. 2 is a schematic cross-sectional view along an axial direction of the heat exchanger;

FIG. 3A is an enlarged explanatory view of a second joint in FIG. 2;

FIG. 3B is an enlarged explanatory view of a first joint in FIG. 2;

FIG. 4 is a schematic cross-sectional view of a gas turbine engine including a diffuser and a nozzle to which a brazing method using a metal film forming tool for brazing according to an embodiment of the present invention can be applied;

FIG. 5 is a perspective view of the diffuser;

FIG. 6 is a cross-sectional view taken along line VI-VI of FIG. 5;

FIG. 7 is a perspective view of the nozzle;

FIG. 8 is a schematic cross-sectional view along the axial direction of the nozzle;

FIG. 9 is an enlarged explanatory view of a fourth joint in FIG. 8;

FIG. 10A is a schematic explanatory view of a metal brush and a support portion of a metal film forming tool for brazing, as viewed in an axial direction;

FIG. 10B is a schematic side view of a metal film forming tool for brazing;

FIG. 11 is a schematic explanatory view for explaining a film formation step of a brazing method using the metal film forming tool for brazing according to the embodiment of the present invention;

FIG. 12A is a cross-sectional view of an inflow-side member and a discharge-side member in which metal films are respectively formed on film formation target portions in the film formation step;

FIG. 12B is an enlarged view of a main part of FIG. 12A;

FIG. 13A is a schematic explanatory view for explaining a brazing material applied to joining target portions in the brazing step of the brazing method using the metal film forming tool for brazing according to the embodiment of the present invention;

FIG. 13B is an enlarged view of a main part of FIG. 13A;

FIG. 14A is a graph showing the relationship between the diameter of a metal wire and the degree of surface roughness of a metal film;

FIG. 14B is a graph showing the relationship between the diameter of the metal wire and the thicknesses of the metal film;

FIG. 14C is a graph showing the relationship between the diameter of the metal wire and the durability of the metal brush;

FIG. 15A is a graph showing the relationship between the length of the metal wire and the degree of surface roughness of the metal film;

FIG. 15B is a graph showing the relationship between the length of the metal wire and the thickness of the metal film; and

FIG. 15C is a graph showing the relationship between the length of the metal wire and the durability of the metal brush.

### DESCRIPTION OF THE INVENTION

In the following drawings, components having the same or similar functions and effects are denoted by the same reference numerals, and repeated description thereof may be omitted.

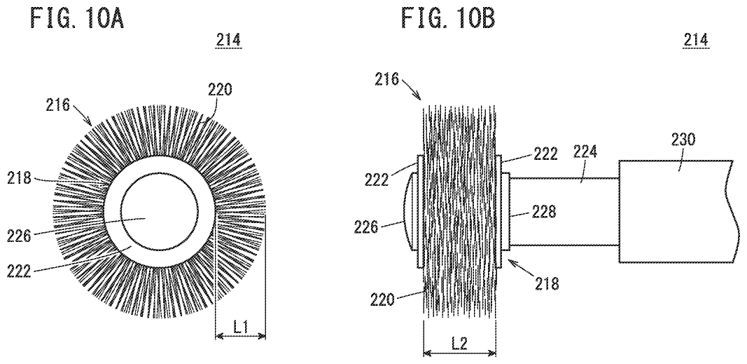

In the brazing method according to the present embodiment, after a metal film is formed on at least one of a pair of joining target portions included in a pair of workpieces, the pair of joining targets are brazed to each other. In this brazing method, a metal film forming tool for brazing 214 (which will be hereinbelow referred to as a brazing metal film forming tool) shown in FIG. 10A and FIG. 10B is suitably used. That is, the brazing metal film forming tool 214 forms a metal film on at least one of the pair of joining target portions before brazing the pair of joining targets included in the pair of workpieces to each other. The above-described brazing method and the brazing metal film forming tool 214 can be more suitably applied to a workpiece having a joining target portion having a relatively small area.

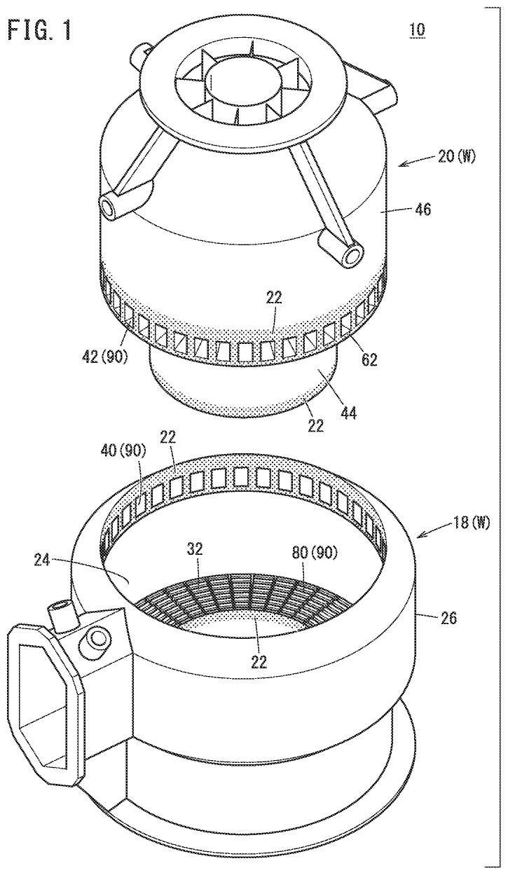

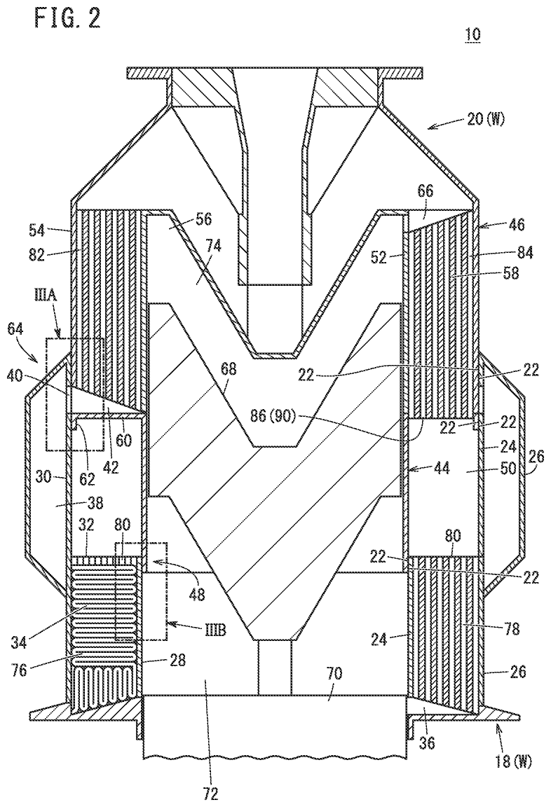

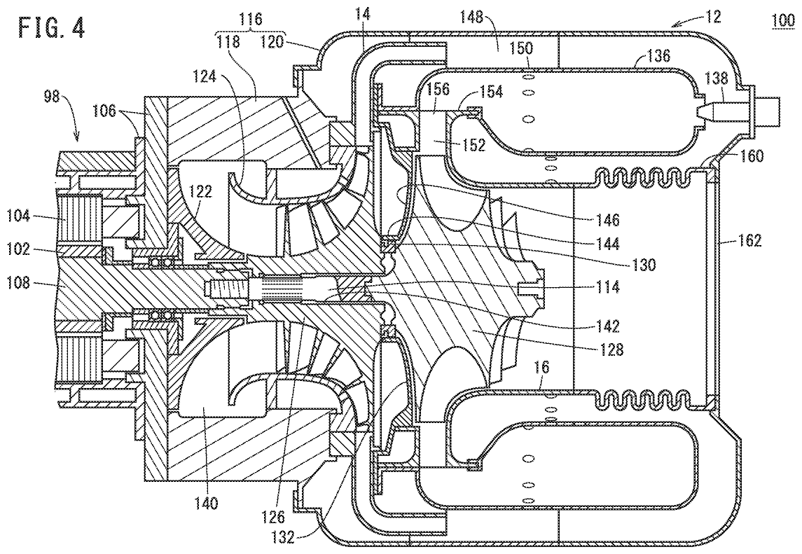

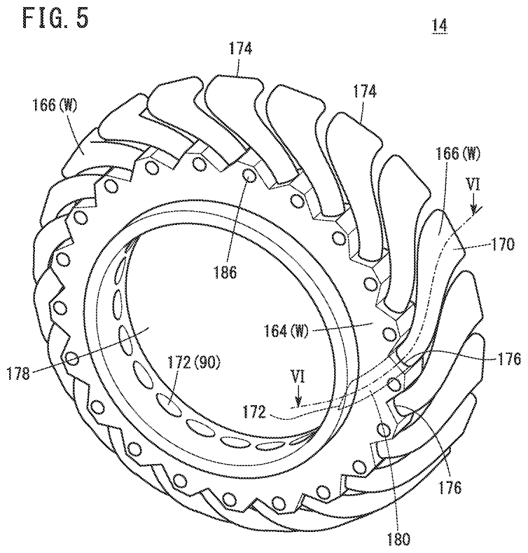

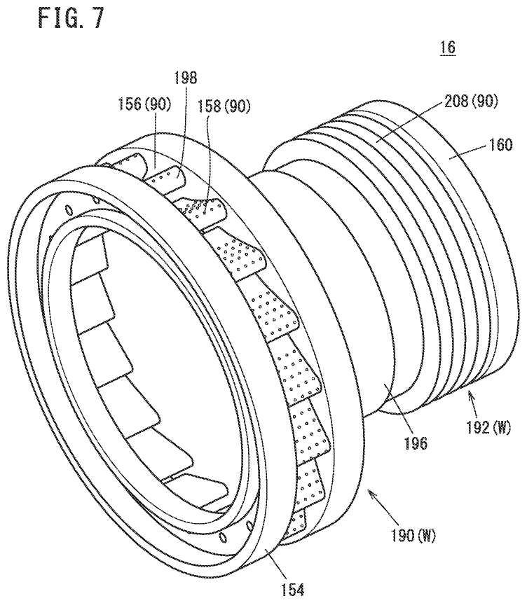

An example of a joined body obtained by brazing workpieces of this type includes a heat exchanger 10 for a Stirling engine shown in FIGS. 1 and 2. Another example of the joined body includes a diffuser 14 (FIG. 5) included in a gas turbine engine 12 shown in FIG. 4. Yet another example of the joined body includes a nozzle 16 (FIG. 7) of the gas turbine engine 12 shown in FIG. 4. However, the workpiece is not limited to the components of the above-described joined body. The brazing metal film forming tool 214 according to the present embodiment can be applied to various workpieces to be brazed, to form a metal film thereon.

Hereinafter, a case where the heat exchanger 10 shown in FIGS. 1 and 2, the diffuser 14 shown in FIG. 5, and the nozzle 16 shown in FIG. 7 are obtained by a brazing method using the brazing metal film forming tool 214 will be described as an example. First, the configuration of the heat exchanger 10 will be briefly described with reference to FIGS. 1 to 3B. In the following description, an upper portion in the drawings of FIGS. 1 to 3B is referred to as an “upper portion”, and a lower portion in the drawings of FIGS. 1 to 3B is referred to as a “lower portion”. However, the actual orientation (posture) of the heat exchanger 10 is not limited to this, and can be variously set according to the usage mode.

The heat exchanger 10 is applied to, for example, a p-type Stirling engine. The heat exchanger 10 has a low-temperature-side portion 18 and a high-temperature-side portion 20 as a pair of workpieces W. As will be described later, the heat exchanger 10 is formed by joining the joining target portion 22 of the low-temperature-side portion 18 and the joining target portion 22 of the high-temperature-side portion 20 by applying a brazing method using the brazing metal film forming tool 214.

The low-temperature-side portion 18 is preferably made of a heat-resistant alloy. Preferable examples of the heat-resistant alloy include a nickel-based alloy containing one or both of titanium and aluminum, and an iron-based alloy containing one or both of titanium and aluminum. However, the material for the low-temperature-side portion 18 is not particularly limited. The low-temperature-side portion 18 may be made of maraging steel, for example.

As shown in FIGS. 1 and 2, the low-temperature-side portion 18 has a tubular shape with both axial ends opened. As shown in FIG. 2, the low-temperature-side portion 18 has a double-tube structure formed by an inner wall 24 and an outer wall 26. The low-temperature-side portion 18 contains a small inner-diameter portion 28 at a lower portion thereof. The low-temperature-side portion 18 further contains a large inner-diameter portion 30 above the small inner-diameter portion 28. The inner diameter of the large inner-diameter portion 30 is larger than the inner diameter of the small inner-diameter portion 28. Further, a step portion 32 is formed between the small inner-diameter portion 28 and the large inner-diameter portion 30, due to a difference in inner diameter therebetween.

A cooling portion 34, which will be described later, is provided between the inner wall 24 and the outer wall 26 of the small inner-diameter portion 28. A plurality of slit-shaped low-temperature-side ports 36 penetrating the inner wall 24 are provided at a lower part of the inner wall 24 of the small inner-diameter portion 28. Although not shown, the plurality of low-temperature-side ports 36 are disposed at intervals in the circumferential direction of the small inner-diameter portion 28. Each low-temperature-side port 36 allows the inside of the inner wall 24 of the small inner-diameter portion 28 to communicate with the cooling portion 34.

A chamber 38 is formed between the inner wall 24 and the outer wall 26 of the large inner-diameter portion 30. The inner wall 24 of the large inner-diameter portion 30 is provided with a plurality of slit-shaped heat source gas outlet ports 40 penetrating the inner wall 24. As shown in FIG. 1, the plurality of heat source gas outlet ports 40 are arranged at intervals in the circumferential direction of the large inner-diameter portion 30. As shown in FIG. 2, each heat source gas outlet port 40 provides communication between the chamber 38 and a heat source gas discharge port 42, described below, of the high-temperature-side portion 20.

The high-temperature-side portion 20 is preferably made of a heat-resistant alloy. Preferable examples of the heat-resistant alloy include a nickel-based alloy containing one or both of titanium and aluminum, and an iron-based alloy containing one or both of titanium and aluminum. However, the material for the high-temperature-side portion 20 is not particularly limited. The high-temperature-side portion 20 may be made of maraging steel, for example.

The high-temperature-side portion 20 has a bottomed tubular shape with a closed upper end and an open lower end. The high-temperature-side portion 20 has a single-tube portion 44 provided at a lower part of the high-temperature-side portion 20 and a double-tube portion 46 provided above the single-tube portion 44. A lower end portion of the single-tube portion 44 is inserted into an upper end portion of the small inner-diameter portion 28 of the low-temperature-side portion 18. Each of an outer peripheral surface of the lower end portion of the single-tube portion 44 and an inner peripheral surface of the upper end portion of the small inner-diameter portion 28 has a joining target portion 22. These joining target portions 22 are joined to each other by brazing after the metal films 92 have been formed by the brazing metal film forming tool 214, thereby forming a first joint 48. Details of the first joint 48 will be described later.

The outer diameter of the single-tube portion 44 is smaller than the inner diameter of the large inner-diameter portion 30 of the low-temperature-side portion 18. An outer peripheral surface of the single-tube portion 44 and an inner peripheral surface of the large inner-diameter portion 30 face each other with a gap therebetween, and a regeneration portion 50, which will be described later, is provided therebetween. The double-tube portion 46 has a double-tube structure formed by an inner wall 52 and an outer wall 54. The inner wall 52 of the double-tube portion 46 extends integrally with the single-tube portion 44 in the axial direction of the single-tube portion 44. The inner side of the inner wall 52 of the double-tube portion 46, the inner side of the single-tube portion 44, and the inner side of the small inner-diameter portion 28 of the low-temperature-side portion 18 integrally form a cylinder chamber 56.

A heating portion 58 described later is provided between the inner wall 52 and the outer wall 54 of the double-tube portion 46. A bottom wall 60 extending between the inner wall 52 and the outer wall 54 is provided at a lower end of the double-tube portion 46 (heating portion 58). The regeneration portion 50 is provided between the bottom wall 60 of the high-temperature-side portion 20 and the step portion 32 of the low-temperature-side portion 18. A plurality of heat source gas discharge ports 42 are provided on a portion of the outer wall 54 of the double-tube portion 46 that lies in the vicinity of the bottom wall 60. As shown in FIG. 1, the plurality of heat source gas discharge ports 42 are arranged at intervals in the circumferential direction of the double-tube portion 46. As shown in FIG. 2, the heat source gas discharge ports 42 face the respective heat source gas outlet ports 40 of the low-temperature-side portion 18. On the outer wall 54 of the double-tube portion 46, a portion reserved for joining 62 is provided below the heat source gas discharge port 42.

The outer peripheral surface of the double-tube portion 46 has a joining target portion 22 around each heat source gas discharge port 42. The inner peripheral surface of the large inner-diameter portion 30 has a joining target portion 22 around each heat source gas outlet port 40. These joining target portions 22 are joined to each other by brazing after the metal films 92 have been formed, thereby forming a second joint 64. Details of the second joint 64 will be described later.

The inner wall 52 contains, near an upper part of the double-tube portion 46, a plurality of slit-shaped high-temperature-side ports 66 penetrating the inner wall 52. Although not shown, the plurality of high-temperature-side ports 66 are disposed at intervals in the circumferential direction of the double-tube portion 46. Each high-temperature-side port 66 allows the cylinder chamber 56 and the heating portion 58 to communicate with each other.

A working gas such as nitrogen gas, helium gas, or the like is sealed inside the cylinder chamber 56. The cylinder chamber 56 contains thereinside a displacer piston 68 and a power piston 70. Each of the displacer piston 68 and the power piston 70 is disposed so as to be capable of reciprocating in the axial direction of the cylinder chamber 56. The displacer piston 68 is disposed above the power piston 70.

Although not shown in the drawings, the displacer piston 68 and the power piston 70 are connected to a crank shaft via different connecting rods. Accordingly, the displacer piston 68 and the power piston 70 can reciprocate while maintaining a phase difference of 90 degrees. The power piston 70 outputs a rotational force to the crankshaft via the connecting rod. The crankshaft is coupled to, for example, a rotating shaft of a generator (not shown).

In the cylinder chamber 56, a low-temperature chamber 72 is formed between the displacer piston 68 and the power piston 70. In the cylinder chamber 56, a high-temperature chamber 74 is formed between the displacer piston 68 and an upper end portion of the cylinder chamber 56. The volumes of the low-temperature chamber 72 and the high-temperature chamber 74 change according to the reciprocating movement of the displacer piston 68 and the power piston 70. When the volume of the high-temperature chamber 74 increases, the volume of the low-temperature chamber 72 decreases.

In the cooling portion 34, a cooling flow path 76 through which a cooling fluid flows and a low-temperature-side working gas flow path 78 through which a working gas flows are provided so as to be able to exchange heat with each other. A cooling fluid is supplied to the cooling flow path 76 from a cooling fluid supply portion (not illustrated). The cooling fluid flowing through the cooling flow path 76 is discharged to a cooling fluid discharge portion (not shown).

One end of the low-temperature-side working gas flow path 78 communicates with the low-temperature chamber 72 via the low-temperature-side ports 36. The other end of the low-temperature-side working gas flow path 78 communicates with the regeneration portion 50 via a first port 80 provided in the step portion 32. The working gas in the low-temperature-side working gas flow path 78 is cooled by heat exchange with the cooling fluid in the cooling flow path 76.

As will be described later, the flow direction of the working gas flowing through the low-temperature-side working gas flow path 78 changes according to changes in the volumes of the low-temperature chamber 72 and the high-temperature chamber 74. When the flow direction of the working gas is a direction from the low-temperature chamber 72 toward the high-temperature chamber 74 via the cooling portion 34, the regeneration portion 50, and the heating portion 58, the working gas in the low-temperature chamber 72 can flow into the low-temperature-side working gas flow path 78 via the low-temperature-side ports 36. The working gas flowing from the low-temperature chamber 72 into the low-temperature-side working gas flow path 78 can flow into the regeneration portion 50 via the first port 80 of the step portion 32.

Conversely, when the flow direction of the working gas is a direction from the high-temperature chamber 74 toward the low-temperature chamber 72 via the heating portion 58, the regeneration portion 50, and the cooling portion 34, the working gas in the regeneration portion 50 can flow into the low-temperature-side working gas flow path 78 via the first port 80 of the step portion 32. The working gas flowing into the low-temperature-side working gas flow path 78 from the regeneration portion 50 can flow into the low-temperature chamber 72 via the low-temperature-side ports 36.

In the heating portion 58, a heating flow path 82 through which a heat source gas flows and a high-temperature-side working gas flow path 84 through which the working gas flows are provided so as to be able to exchange heat with each other. The heat source gas is supplied to the heating flow path 82 from a heat source gas supply portion (not illustrated). The heat source gas flowing through the heating flow path 82 is discharged to a heat source gas discharge portion (not shown) via the heat source gas discharge port 42 of the high-temperature-side portion 20, the heat source gas outlet port 40 of the low-temperature-side portion 18, and the chamber 38.

One end of the high-temperature-side working gas flow path 84 communicates with the high-temperature chamber 74 via the high-temperature-side ports 66. The other end of the high-temperature-side working gas flow path 84 communicates with the regeneration portion 50 via a second port 86 provided in the bottom wall 60 of the high-temperature-side portion 20. The working gas in the high-temperature-side working gas flow path 84 is heated by heat exchange with the heat source gas in the heating flow path 82.

When the flow direction of the working gas is a direction from the high-temperature chamber 74 toward the low-temperature chamber 72 via the heating portion 58, the regeneration portion 50, and the cooling portion 34, the working gas in the high-temperature chamber 74 can flow into the high-temperature-side working gas flow path 84 via the high-temperature-side ports 66. The working gas flowing from the high-temperature chamber 74 into the high-temperature-side working gas flow path 84 can flow into the regeneration portion 50 via the second port 86 of the bottom wall 60.

Conversely, when the flow direction of the working gas is a direction from the low-temperature chamber 72 toward the high-temperature chamber 74 via the cooling portion 34, the regeneration portion 50, and the heating portion 58, the working gas in the regeneration portion 50 can flow into the high-temperature-side working gas flow path 84 via the second port 86 of the bottom wall 60. The working gas flowing into the high-temperature-side working gas flow path 84 from the regeneration portion 50 can flow into the high-temperature chamber 74 via the high-temperature-side ports 66.

Although not shown, the regeneration portion 50 is provided with a heat storage material formed by compression-forming metal fibers having thermal conductivity. The heat storage material has voids therein. The working gas can flow through the heat storage material via the voids. The working gas flowing from the cooling portion 34 into the regeneration portion 50 through the first port 80 of the step portion 32 moves upward in the regeneration portion 50 and flows into the heating portion 58 through the second port 86 of the bottom wall 60. Conversely, the working gas flowing from the heating portion 58 into the regeneration portion 50 through the second port 86 of the bottom wall 60 moves downward in the regeneration portion 50 and flows into the cooling portion 34 through the first port 80 of the step portion 32.

When the working gas moves from the high-temperature chamber 74 to the low-temperature chamber 72, the regeneration portion 50 performs the same function as the cooling portion 34 that cools the high-temperature working gas by storing heat in the heat storage material. Conversely, when the working gas moves from the low-temperature chamber 72 to the high-temperature chamber 74, the regeneration portion 50 performs the same function as the heating portion 58 by providing the thermal energy stored in the heat storage material to the working gas. As a result, the fuel efficiency of the Stirling engine can be improved.

In the Stirling engine configured as described above, when the displacer piston 68 is at the top dead center position, the volume of the low-temperature chamber 72 is maximized. At this time, the working gas in the cylinder chamber 56 is mainly in the low-temperature chamber 72 and is cooled by heat exchange with the cooling portion 34. As a result, the working gas in the cylinder chamber 56 contracts and a negative pressure acts on the power piston 70, so that the power piston 70 receives a driving force in the upward direction. When the power piston 70 moves upward, the crank shaft connected to the power piston 70 via the connecting rod rotates. When the crank shaft rotates, the displacer piston 68 connected to the crank shaft via the connecting rod descends.

When the displacer piston 68 descends, the volume of the high-temperature chamber 74 increases, the volume of the low-temperature chamber 72 decreases, and the working gas flows from the low-temperature chamber 72 to the high-temperature chamber 74 through the cooling portion 34, the regeneration portion 50, and the heating portion 58. In this case, the working gas is heated by passing through the regeneration portion 50 and the heating portion 58.

When the power piston 70 is positioned at the top dead center, the working gas in the cylinder chamber 56 is mainly in the high-temperature chamber 74 and is heated by heat exchange with the heating portion 58 of the heat exchanger 10. As a result, the working gas in the cylinder chamber 56 expands and a positive pressure acts on the power piston 70, and the power piston 70 receives a driving force in the descending direction. When the power piston 70 descends, the crank shaft coupled to the power piston 70 via the connecting rod rotates.

The displacer piston 68 reaches the bottom dead center point, and the displacer piston 68 then starts rising. As a result, the volume of the high-temperature chamber 74 decreases and the volume of the low-temperature chamber 72 increases, and the working gas flows from the high-temperature chamber 74 to the low-temperature chamber 72 through the heating portion 58, the regeneration portion 50, and the cooling portion 34. The working gas is cooled by passing through the regeneration portion 50 and the heating portion 58.

When the power piston 70 is positioned at the bottom dead center, the working gas in the cylinder chamber 56 is mainly in the low-temperature chamber 72, and is cooled by heat exchange with the cooling portion 34 of the heat exchanger 10. As a result, the working gas in the cylinder chamber 56 contracts and a negative pressure acts on the power piston 70, so that the power piston 70 receives a driving force in the upward direction. When the power piston 70 moves upward, the crank shaft connected to the power piston 70 via the connecting rod rotates. The above-described process is repeatedly performed, and the crank shaft rotates, whereby electricity is generated by the generator.

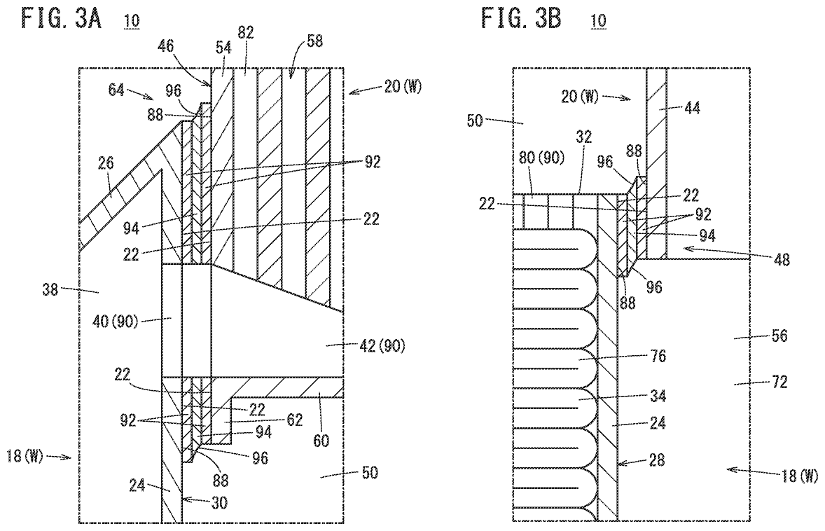

As described above, in the heat exchanger 10, the first joint 48 and the second joint 64 are provided as joint portions between the low-temperature-side portion 18 and the high-temperature-side portion 20. As shown in FIG. 3B, in the first joint 48, the low-temperature-side portion 18 (workpiece W) has, in addition to the joining target portion 22, a brazing-material-allowed portion 88 adjacent to a lower portion of the joining target portion 22, and an avoidance portion 90 in which formation of the metal film 92 is not allowed. The brazing-material-allowed portion 88 of the low-temperature-side portion 18 is provided below a portion of the inner peripheral surface of the small inner-diameter portion 28 that overlaps the single-tube portion 44 of the high-temperature-side portion 20. The avoidance portion 90 of the low-temperature-side portion 18 is a first port 80 for the working gas, formed in the step portion 32. In other words, the avoidance portion 90 is a portion in which an opening through which the working gas (fluid) can flow is formed.

It is preferable that a coating layer for improving the heat resistance of the low-temperature-side portion 18 is provided on a surface of the low-temperature-side portion 18 excluding the joining target portion 22 and the brazing-material-allowed portion 88. Examples of the material for the coating layer include ceramics such as alumina and silica, but are not particularly limited thereto. In a case where such a coating layer is provided on the surface of the low-temperature-side portion 18, the avoidance portion 90 also includes a region where the coating layer is formed.

As shown in FIG. 3B, in the first joint 48, the high-temperature-side portion 20 (workpiece W) has, in addition to the joining target portion 22, a brazing-material-allowed portion 88 adjacent to an upper portion of the joining target portion 22. The brazing-material-allowed portion 88 of the high-temperature-side portion 20 is provided above a portion of the outer peripheral surface of the single-tube portion 44 that overlaps the small inner-diameter portion 28 of the low-temperature-side portion 18.

It is preferable that a coating layer for improving the heat resistance of the high-temperature-side portion 20 is provided on a surface of the high-temperature-side portion 20 excluding the joining target portion 22 and the brazing-material-allowed portion 88. An example of the material for the coating layer is the same as that for the coating layer of the low-temperature-side portion 18. When such a coating layer is provided on the surface of the high-temperature-side portion 20, the high-temperature-side portion 20 further includes an avoidance portion 90 which is a portion where the coating layer is formed.

In the first joint 48, the metal film 92 is formed on a film formation target portion that includes the joining target portion 22 and the brazing-material-allowed portion 88 but does not include the avoidance portion 90. A brazing material 94 for joining the joining target portion 22 of the low-temperature-side portion 18 and the joining target portion 22 of the high-temperature-side portion 20 is disposed on the metal film 92. Therefore, a fillet 96 made of the solidified brazing material 94 is formed on the brazing-material-allowed portion 88.

As shown in FIG. 3A, in the second joint 64, the low-temperature-side portion 18 (workpiece W) includes, in addition to the joining target portion 22, a brazing-material-allowed portion 88 adjacent to a lower portion of the joining target portion 22, and an avoidance portion 90 in which formation of the metal film 92 is not allowed. The brazing-material-allowed portion 88 of the low-temperature-side portion 18 is provided below a portion of the inner peripheral surface of the large inner-diameter portion 30 that overlaps with the portion reserved for joining 62 of the high-temperature-side portion 20. The avoidance portion 90 of the second joint 64 is the heat source gas outlet port 40. In other words, the avoidance portion 90 is a portion in which an opening through which the heat source gas (fluid) can flow is formed. In a case where the coating layer is provided on the surface of the low-temperature-side portion 18, the avoidance portion 90 also includes a portion where the coating layer is formed.

In the second joint 64, the high-temperature-side portion 20 (workpiece W) includes, in addition to the joining target portion 22, a brazing-material-allowed portion 88 adjacent to an upper portion of the joining target portion 22, and an avoidance portion 90 in which formation of the metal film 92 is not allowed. The brazing-material-allowed portion 88 of the high-temperature-side portion 20 is provided above a portion of the outer wall 54 of the double-tube portion 46 that overlaps the large inner-diameter portion 30 of the low-temperature-side portion 18. The avoidance portion 90 of the high-temperature-side portion 20 includes the heat source gas discharge port 42 and the second port 86. In other words, the avoidance portion 90 is a portion in which an opening through which the heat source gas or the working gas (fluid) can flow is formed. In addition, when the coating layer is provided on the surface of the high-temperature-side portion 20, the avoidance portion 90 also includes a region where the coating layer is formed.

In the second joint 64, the metal film 92 is formed on a film formation target portion that includes the joining target portion 22 and the brazing-material-allowed portion 88 but does not include the avoidance portion 90. In other words, in the second joint 64, the metal film 92 is formed on each of an upper portion above the avoidance portion 90 (the heat source gas outlet port 40 and the heat source gas discharge port 42) and a lower portion below the avoidance portion 90. A brazing material 94 for joining the joining target portion 22 of the low-temperature-side portion 18 and the joining target portion 22 of the high-temperature-side portion 20 is disposed on the metal film 92. Therefore, a fillet 96 made of the solidified brazing material 94 is formed on the brazing-material-allowed portion 88.

Next, the structure of the gas turbine engine 12 including the diffuser 14 and the nozzle 16 will be briefly described mainly with reference to FIG. 4. In the following description, an upper portion in FIG. 4 is referred to as an “upper portion”, and a lower portion in FIG. 4 is referred to as a “lower portion”. Further, a left portion in FIG. 4 will be described as a “left portion”, and a right portion in FIG. 4 will be described as a “right portion”. However, the actual orientation (posture) of the gas turbine engine 12 is not limited to these, and can be set in various ways depending on the mode of use.

The gas turbine engine 12 is integrated with, for example, a rotary electric machine 98 to constitute a combined power system 100. The combined power system 100 can be used as, for example, a power source for propulsion in a flying object such as a drone, a ship, an automobile, or the like, or a power source for an auxiliary power supply in an aircraft, a ship, a building, or the like. The gas turbine engine 12 and the rotary electric machine 98 are arranged side by side on the same axis. The gas turbine engine 12 is disposed to the right of the rotary electric machine 98. In FIG. 4, only the portion of the rotary electric machine 98 connected to the gas turbine engine 12 and its vicinity are shown, and the other portions are not shown.

The rotary electric machine 98 includes a rotor 102 and a stator 104 surrounding an outer peripheral side of the rotor 102. The rotary electric machine 98 is housed in a rotary electric machine housing 106. The rotor 102 is provided on the outer periphery of a rotary shaft 108. An output shaft 114 of the gas turbine engine 12 is coupled to a right end portion of the rotary shaft 108.

The gas turbine engine 12 includes an engine housing 116. The engine housing 116 includes an inner housing 118 coupled to the rotary electric machine housing 106 and an outer housing 120 coupled to the inner housing 118. In addition to the engine housing 116, the gas turbine engine 12 includes a flow directing member 122, a shroud case 124, a compressor wheel 126, a turbine wheel 128, a ring member 130, an intermediate plate 132, a diffuser 14, a combustor 136, and a nozzle 16. These components are housed inside the engine housing 116.

The flow directing member 122 is fixed to the rotary electric machine housing 106 in a state in which the rotary shaft 108 is inserted into the flow directing member 122. The shroud case 124 is a hollow body. A right end portion of the flow directing member 122 and a left end portion of the shroud case 124 are disposed side by side at an interval in the axial direction of the rotary shaft 108. The left end portion of the shroud case 124 is disposed in an intake space 140 that communicates with the outside of the inner housing 118.

The compressor wheel 126 is rotatably accommodated in the shroud case 124. As will be described later, when the compressor wheel 126 is rotationally driven, air is taken in between the inner wall surface of the shroud case 124 and the compressor wheel 126 via the intake space 140. Each of the compressor wheel 126 and the turbine wheel 128 is supported on the output shaft 114. As described above, the output shaft 114 and the rotary shaft 108 of the rotary electric machine 98 are coupled to each other. Therefore, the compressor wheel 126 and the turbine wheel 128 can rotate integrally with the rotary shaft 108.

A shaft hole 142 extending along the left-right direction is formed so as to penetrate through the center of the compressor wheel 126 in the radial direction. In a state where the output shaft 114 is inserted into the shaft hole 142, the compressor wheel 126 and the output shaft 114 are, for example, spline-coupled to each other. Further, inside the shaft hole 142, the rotary shaft 108 is coupled to a left end portion of the output shaft 114, and a left end portion of the turbine wheel 128 is coupled to a right end portion of the output shaft 114.

A ring member 130 is interposed between the compressor wheel 126 and the turbine wheel 128. The outer periphery of the ring member 130 is surrounded by a tubular portion 144 of the intermediate plate 132. The intermediate plate 132 includes an annular extending portion 146 extending from the right end portion of the tubular portion 144 toward the outer side in the radial direction of the tubular portion 144. A portion of the extending portion 146 other than an outer edge portion thereof is disposed between the compressor wheel 126 and the turbine wheel 128. The outer edge portion of the extending portion 146 is disposed between the combustor 136 and the diffuser 14.

An annular combustion air flow passage 148 through which combustion air flows is formed between an outer peripheral surface of the combustor 136 and an inner peripheral surface of the outer housing 120. The diffuser 14 is provided at a beginning part of the combustion air flow passage 148. As will be described later, the diffuser 14 converts kinetic energy (velocity energy) of compressed air taken in and compressed between the shroud case 124 and the compressor wheel 126, into pressure energy. As a result, combustion air obtained by converting the kinetic energy of the compressed air into pressure energy is supplied to the combustion air flow passage 148. Details of the structure of the diffuser 14 will be described later.

A relay hole 150 for communicating the inside of the combustor 136 with the combustion air flow passage 148 is formed in the combustor 136. The combustor 136 is also formed with fine holes (not shown) for forming an air curtain for cooling the inside of the combustor 136. The combustion air in the combustion air flow passage 148 reaches the inside of the combustor 136 via the relay hole 150. A fuel supply nozzle 138 for supplying fuel to the combustor 136 is positioned and fixed to a right end surface of the outer housing 120. Therefore, a combustion reaction between the combustion air and the fuel can be caused inside the combustor 136.

The combustor 136 has a discharge port 152 for discharging burned fuel (synonymous with “combustion gas” and “exhaust gas after combustion”) generated by the above combustion reaction. The burned fuel discharged from the discharge port 152 of the combustor 136 flows toward a delivery hole 156 formed in the peripheral wall of a large-diameter portion 154 of the nozzle 16. The turbine wheel 128 is rotatably disposed inside the nozzle 16. The nozzle 16 converts pressure energy of the burned fuel into kinetic energy (velocity energy) and transmits the kinetic energy to the turbine wheel 128. Therefore, the burned fuel introduced into the nozzle 16 through the delivery hole 156 rotates the turbine wheel 128.

A plurality of small holes 158 (FIG. 7) are formed in portions of the peripheral wall of the large-diameter portion 154 of the nozzle 16, other than the delivery hole 156. A part of the compressed air taken in and compressed between the shroud case 124 and the compressor wheel 126 via the intake space 140 (hereinafter, also referred to as “split air”) is sent to the small holes 158 from the outside in the radial direction of the nozzle 16 via a branch path (not illustrated). The small holes 158 allow the split air to pass from the outer side toward the inner side in the radial direction of the nozzle 16. Thus, the split air introduced into the nozzle 16 forms an air curtain that cools the interior of the nozzle 16. Details of the configuration of the nozzle 16 will be described later.

After transmitting the kinetic energy to the turbine wheel 128, the burned fuel is discharged from an opening of a fixed tubular portion 160 provided at a right end portion of the nozzle 16. An opening of the fixed tubular portion 160 of the nozzle 16 communicates with a burned fuel discharge port 162 formed at a right end portion of the outer housing 120. The fixed tubular portion 160 of the nozzle 16 is fixed to a peripheral edge of the burned fuel discharge port 162 of the outer housing 120. The burned fuel discharge port 162 is provided with a discharge pipe (not shown) for discharging the burned fuel. Therefore, the burned fuel is blown to the outside of the outer housing 120 through the burned fuel discharge port 162 by the action of the rotating turbine wheel 128.

The operation of the gas turbine engine 12 configured as described above will be briefly described. In the gas turbine engine 12, the rotary shaft 108 is rotated by, for example, a known starter. The rotational torque of the rotary shaft 108 is transmitted to the output shaft 114. Therefore, the compressor wheel 126 and the turbine wheel 128 supported by the output shaft 114 rotate integrally with the output shaft 114. As a result, atmospheric air is sucked from the intake space 140 into the shroud case 124. The sucked air is directed, by the flow directing member 122, so as to flow toward the shroud case 124.

The air sucked into the shroud case 124 flows between the compressor wheel 126 and the shroud case 124, and is compressed. This produces compressed air. The compressed air flows into the diffuser 14 and becomes combustion air. The combustion air discharged from the diffuser 14 flows into the combustion air flow passage 148. The combustion air enters the inside (combustion chamber) of the combustor 136 via, for example, the relay hole 150 and the fine holes formed in the combustor 136 and the clearance between the combustor 136 and the fuel supply nozzle 138.

The combustor 136 is heated in advance. Further, fuel is supplied into the combustor 136 from a fuel supply nozzle 138. The fuel becomes a high-temperature burned fuel by a combustion reaction with the combustion air. The burned fuel is supplied from the delivery hole 156 into the nozzle 16, and expands in the nozzle 16, whereby the turbine wheel 128 rotates at a high speed. Accordingly, the output shaft 114 and the compressor wheel 126 integrally rotate at a high speed. The burned fuel is discharged to the outside of the outer housing 120 through a discharge pipe provided in the burned fuel discharge port 162.

When the output shaft 114 starts to rotate at a high speed, the rotary shaft 108 integrally rotates at a high speed. Accordingly, since the rotor 102 provided on the outer periphery of the rotary shaft 108 rotates relative to the stator 104, it is possible to obtain electric power by the combined power system 100.

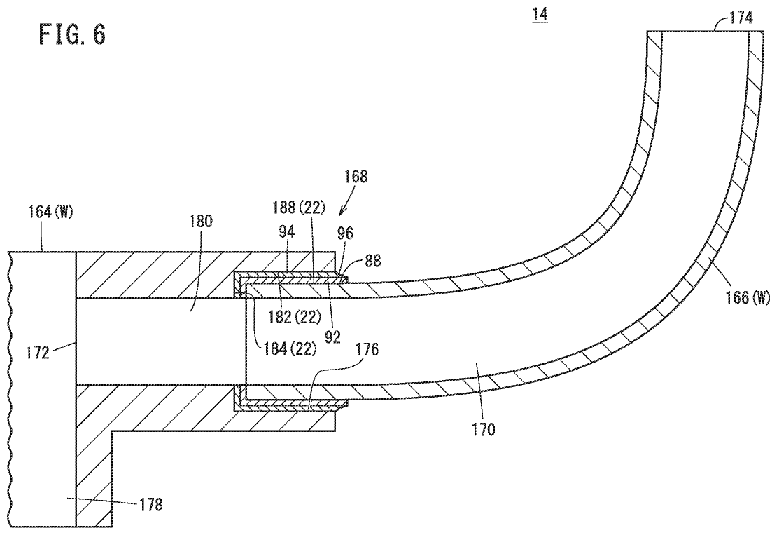

The configuration of the diffuser 14 will be described in detail with reference to FIGS. 4 to 6. As shown in FIGS. 5 and 6, the diffuser 14 includes an inlet member 164 and a plurality of outlet members 166. The inlet member 164 and each of the plurality of outlet members 166 are joined by brazing to form the diffuser 14. Hereinafter, a joint portion between the inlet member 164 and each outlet member 166 is also referred to as a third joint 168. Details of the third joint 168 will be described later.

The diffuser 14 defines a plurality of diffuser flow passages 170. Compressed air flows in from a flow passage inlet 172 of each diffuser flow passage 170. Each diffuser flow passage 170 changes the flow direction of the compressed air from the radial direction of the compressor wheel 126 in FIG. 4 to the axial direction thereof, and makes the compressed air into combustion air. Then, the combustion air is discharged from the flow passage outlet 174 of each diffuser flow passage 170.

The inlet member 164 is preferably made of a heat-resistant alloy. Preferable examples of the heat-resistant alloy include a nickel-based alloy containing one or both of titanium and aluminum, and an iron-based alloy containing one or both of titanium and aluminum. As shown in FIG. 5, the inlet member 164 has a plurality of flow passage inlets 172 and a plurality of connection ports 176 equal in number to the flow passage inlets 172. The inlet member 164 has a substantially disk shape (annular shape) having a hole 178 at the center in the radial direction of the inlet member 164. The compressor wheel 126 of FIG. 4 is rotatably disposed inside the hole 178.

Each of the flow passage inlets 172 is opened in the inner wall of the inlet member 164 on the radial center side. The plurality of flow passage inlets 172 are arranged at intervals in the circumferential direction of the inlet member 164. Each of the connection ports 176 is opened in the outer wall of the inlet member 164 on the radial outer side. The plurality of connection ports 176 are arranged at intervals in the circumferential direction of the inlet member 164. The inlet member 164 is formed with through passages 180 that connect the flow passage inlets 172 and the connection ports 176 on a one-to-one basis. A part of the diffuser flow passage 170 is formed inside the through passage 180.

As shown in FIG. 6, an insertion port 182 is provided in the vicinity of the flow passage inlet 172 of the through passage 180. The flow passage cross-sectional area of the insertion port 182 is larger than the flow passage cross-sectional area of a portion of the through passage 180 adjacent to the insertion port 182. Therefore, a stepped surface 184 is provided between the insertion port 182 and the portion of the through passage 180 adjacent to the insertion port 182. In the inlet member 164, the joining target portions 22 are provided on the inner wall surface of the insertion port 182 and on the stepped surface 184.

The inlet member 164 includes through holes 186 passing through the inlet member 164 in the axial direction. When viewed in the axial direction of the inlet member 164, each through hole 186 is formed between the connection ports 176 adjacent to each other in the circumferential direction of the inlet member 164. The inlet member 164, the outer edge portion of the extending portion 146 of the intermediate plate 132, and the combustor 136 are fastened together, for example, by bolt fixation via the through holes 186.

Each outlet member 166 is preferably made of a heat-resistant alloy. Preferable examples of the heat-resistant alloy include a nickel-based alloy containing one or both of titanium and aluminum, and an iron-based alloy containing one or both of titanium and aluminum. As shown in FIGS. 5 and 6, each outlet member 166 has a pipe shape, and contains therein the diffuser flow passage 170. As shown in FIG. 6, one end portion of each outlet member 166 in the extending direction has an insertion portion 188 to be inserted into the insertion port 182 of the inlet member 164. In each outlet member 166, the joining target portions 22 are provided on the outer peripheral surface of the insertion portion 188 and on the end surface of the insertion portion 188. After the metal films 92 are formed on the joining target portions 22 of the outlet member 166, the joining target portions 22 of the outlet member 166 and the joining target portions 22 of the inlet member 164 are joined together by brazing, thereby forming the third joint 168.

A flow passage outlet 174 is provided at the other end portion of each outlet member 166 in the extending direction. As shown in FIG. 5, each outlet member 166 has a portion curved with respect to the radial direction of the inlet member 164 and a portion curved in a direction rising up along the axial direction of the inlet member 164, on the way of extending from the insertion portion 188 toward the flow passage outlet 174.

By joining the joining target portions 22 of the inlet member 164 and the joining target portions 22 of the outlet member 166 as described above, the inside of the through passage 180 of the inlet member 164 and the inside of the outlet member 166 communicate with each other. Accordingly, the inlet member 164 and the outlet member 166 integrally form the diffuser flow passage 170.

In the third joint 168, the inlet member 164 (workpiece W) has an avoidance portion 90 (FIG. 5) in which formation of the metal film 92 is not allowed, in addition to the joining target portions 22 (FIG. 6). The avoidance portion 90 of the inlet member 164 is a flow passage inlet 172. In other words, the avoidance portion 90 of the inlet member 164 is a portion in which an opening through which compressed air (fluid) can flow is formed. The flow passage inlet 172 is required to have high dimensional accuracy. Therefore, it is required to avoid a situation where a change in the dimension of the flow passage inlet 172 is caused by the formation of the metal film 92 on the inner wall surface of the flow passage inlet 172 and on the wall surface in the vicinity of the flow passage inlet 172.

As shown in FIG. 6, in the third joint 168, the outlet member 166 (workpiece W) has a brazing-material-allowed portion 88 adjacent to the joining target portion 22, in addition to the joining target portion 22. The brazing-material-allowed portion 88 is disposed on the outer peripheral surface of each outlet member 166, more specifically adjacent to the insertion portion 188 and outside the insertion port 182.

In the third joint 168, the metal film 92 is formed on a film formation target portion that includes the joining target portions 22 and the brazing-material-allowed portion 88 but does not include the avoidance portion 90. A brazing material 94 for joining the joining target portion 22 of the inlet member 164 and the joining target portion 22 of the outlet member 166 is disposed on the metal film 92. Therefore, a fillet 96 made of the solidified brazing material 94 is formed on the brazing-material-allowed portion 88.

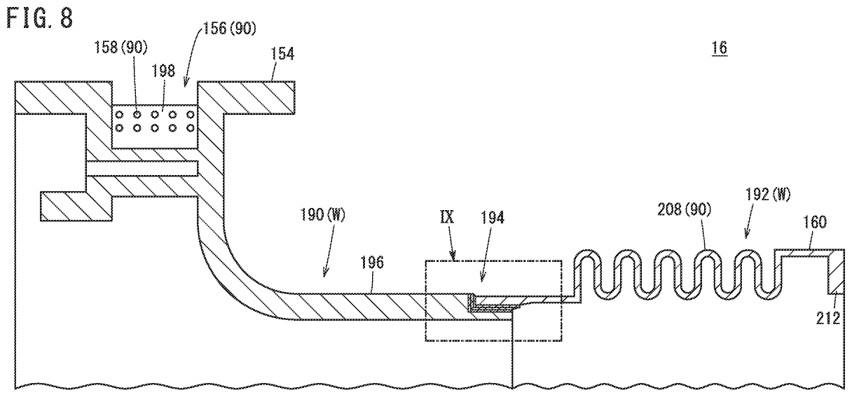

The configuration of the nozzle 16 will be described in detail with reference to FIGS. 4, 7, 8, and 9. As shown in FIGS. 7 and 8, the nozzle 16 is configured by joining an inflow-side member 190 and a discharge-side member 192 by brazing. Hereinafter, a joint portion between the inflow-side member 190 and the discharge-side member 192 is also referred to as a fourth joint 194. Details of the fourth joint 194 will be described later.

The inflow-side member 190 is preferably made of a heat-resistant alloy. Preferable examples of the heat-resistant alloy include a nickel-based alloy containing one or both of titanium and aluminum, and an iron-based alloy containing one or both of titanium and aluminum. The inflow-side member 190 has a hollow shape, and the turbine wheel 128 of FIG. 4 is rotatably disposed inside the inflow-side member 190.

Specifically, as shown in FIGS. 7 and 8, the inflow-side member 190 includes a large-diameter portion 154 and an intermediate shaft portion 196 having an inner diameter smaller than that of the large-diameter portion 154. The large-diameter portion 154 is provided with a plurality of fins 198 arranged at intervals in the circumferential direction of the large-diameter portion 154. The delivery holes 156 are provided between the fins 198 adjacent to each other in the circumferential direction of the large diameter portion 154 in order to establish communication between the inside and the outside of the large-diameter portion 154. The delivery hole 156 faces the discharge port 152 of the combustor 136 of FIG. 4, and allows the burned fuel discharged from the discharge port 152 to flow toward the inside of the large-diameter portion 154.

A plurality of small holes 158 are formed in each fin 198 constituting a peripheral wall of the large-diameter portion 154. As described above, these small holes 158 form an air curtain that cools the inside of the nozzle 16 by allowing the split air to flow from the outer side to the inner side in the radial direction of the large-diameter portion 154 (nozzle 16).

The intermediate shaft portion 196 extends in the axial direction of the nozzle 16. As shown in FIG. 8, one end portion of the intermediate shaft portion 196 in the extending direction is integrally connected to the large-diameter portion 154. A small outer diameter portion 200 is provided at the other end portion of the intermediate shaft portion 196 in the extending direction. The outer diameter of the small outer diameter portion 200 is smaller than the outer diameter of a portion of the intermediate shaft portion 196 adjacent to the small outer diameter portion 200. Therefore, a stepped surface 202 is provided between the small outer diameter portion 200 and the portion of the intermediate shaft portion 196 adjacent to the small outer diameter portion 200. In the inflow-side member 190, the joining target portions 22 are provided on the outer peripheral surface of the small outer diameter portion 200 and on the stepped surface 202.

The discharge-side member 192 is preferably made of a heat-resistant alloy. Preferable examples of the heat-resistant alloy include a nickel-based alloy containing one or both of titanium and aluminum, and an iron-based alloy containing one or both of titanium and aluminum. The discharge-side member 192 includes an external fitting tubular portion 204, a fixed tubular portion 160, and a bellows portion 208. The external fitting tubular portion 204 has an external fitting end portion 210 that is externally fitted onto the small outer diameter portion 200 of the inflow-side member 190. The fixed tubular portion 160 is fixed to the peripheral edge of the burned fuel discharge port 162 of the outer housing 120 of FIG. 4. The bellows portion 208 is provided between the external fitting tubular portion 204 and the fixed tubular portion 160.

An inner diameter of the external fitting end portion 210 is slightly larger than an outer diameter of the small outer diameter portion 200 of the inflow-side member 190. The small outer diameter portion 200 is inserted into the external fitting end portion 210. In the discharge-side member 192, the joining target portions 22 are provided on the inner peripheral surface of the external fitting end portion 210 and on the end surface of the external fitting end portion 210. After the metal film 92 is formed on each of the joining target portions 22 of the inflow-side member 190 and the joining target portions 22 of the discharge-side member 192, the joining target portions 22 of the inflow-side member 190 and the joining target portions 22 of the discharge-side member 192 are joined by brazing to form the fourth joint 194.

The outer diameter of the fixed tubular portion 160 is larger than the outer diameter of the external fitting tubular portion 204. The fixed tubular portion 160 includes a flange 212 at an end thereof opposite to an end where the bellows portion 208 is disposed. The flange 212 protrudes from the inner peripheral surface of the fixed tubular portion 160 toward the center in the radial direction of the fixed tubular portion 160. For example, the fixed tubular portion 160 is fixed to the peripheral edge portion of the burned fuel discharge port 162 of the outer housing 120 of FIG. 4 by bolting via the flange 212.

As shown in FIG. 8, the wall portion constituting the bellows portion 208 has a concavo-convex shape (bellows structure) which meanders in the axial direction of the nozzle 16. The bellows portion 208 can expand and contract in the axial direction of the nozzle 16. Further, the bellows portion 208 can be bent and deformed in the radial direction of the nozzle 16. The nozzle 16 and the components of the gas turbine engine 12 (FIG. 4), such as the outer housing 120 to which the nozzle 16 is secured, may undergo dimensional change at different ratios due to, for example, temperature difference and difference in the thermal expansion coefficient of material that occur therebetween. Even in this case, since the bellows portion 208 is deformable as described above, it is possible to suppress the occurrence of stress between the nozzle 16 and the other components. As a result, the durability of the gas turbine engine 12 can be improved.

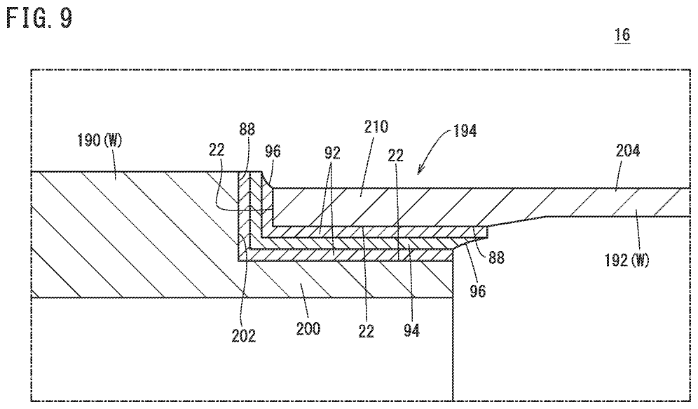

In the fourth joint 194, the inflow-side member 190 (workpiece W) includes, in addition to the joining target portion 22, a brazing-material-allowed portion 88 adjacent to the joining target portion 22, and an avoidance portion 90 in which formation of the metal film 92 is not allowed. As shown in FIG. 9, the brazing-material-allowed portion 88 of the inflow-side member 190 is provided on the stepped surface 202. Specifically, the brazing-material-allowed portion 88 is provided on a portion of the stepped surface 202 that lies more outward in the radial direction of the inflow-side member 190, than a portion thereof that faces the end surface of the external fitting end portion 210. The avoidance portion 90 of the inflow-side member 190 includes the delivery holes 156 through which the burned fuel flows, and the small holes 158 through which the split air passes. In other words, the avoidance portion 90 is a portion in which an opening through which the burned fuel or the split air (fluid) can flow is formed. It is preferable that a coating layer for improving heat resistance and oxidation resistance of the inflow-side member 190 be provided on the surface of the inflow-side member 190 except for the joining target portions 22. An example of the material for the coating layer may include the same material as that for the coating layer of the low-temperature-side portion 18. When such a coating layer is provided on the surface of the inflow-side member 190, the avoidance portion 90 also includes a region on which the coating layer is formed.

In the fourth joint 194, the discharge-side member 192 (workpiece W) includes, in addition to the joining target portion 22, a brazing-material-allowed portion 88 adjacent to the joining target portion 22, and an avoidance portion 90 in which formation of the metal film 92 is not allowed. As shown in FIG. 9, the brazing-material-allowed portion 88 of the discharge-side member 192 is provided at a portion of the inner peripheral surface of the external fitting tubular portion 204 that lies adjacent to the small outer diameter portion 200 of the inflow-side member 190. As shown in FIG. 8, the avoidance portion 90 of the discharge-side member 192 is a bellows portion 208. In other words, the avoidance portion 90 is a portion where an uneven portion (concavo-convex portion) is formed. A coating layer for improving heat resistance and oxidation resistance of the discharge-side member 192 may be or may not be provided on the surface of the discharge-side member 192 excluding the joining target portions 22 and the brazing-material-allowed portion 88. When such a coating layer is provided, examples of the material for the coating layer include the same materials as those for the coating layer of the low-temperature-side portion 18. When the coating layer is provided on the surface of the discharge-side member 192, the avoidance portion 90 also includes a portion on which the coating layer is formed.

In the fourth joint 194, as shown in FIG. 9, the metal film 92 is formed on a film formation target portion that includes the joining target portions 22 and the brazing-material-allowed portion 88 but does not include the avoidance portion 90. A brazing material 94 for joining the joining target portions 22 of the inflow-side member 190 and the joining target portions 22 of the discharge-side member 192 is disposed on the metal film 92. Therefore, a fillet 96 made of the solidified brazing material 94 is formed on the brazing-material-allowed portion 88.

Hereinafter, an example in which the fourth joint 194 is formed by applying the brazing method using the brazing metal film forming tool 214 will be described, but it is also possible to form the first joint 48, the second joint 64, and the third joint 168 in the same manner as in the case of forming the fourth joint 194.

The brazing method includes a film formation step (brazing pretreatment step) of forming the metal film 92 on the film formation target portion of the fourth joint 194. In the film formation step, the metal film 92 is formed on the film formation target portion shown in FIG. 9, using, for example, a metal film forming tool for brazing (brazing metal film forming tool) 214 shown in FIG. 10A and FIG. 10B.

The brazing metal film forming tool 214 includes a metal brush 216 and a support portion 218. The metal brush 216 has a brush shape formed by bundling a plurality of metal wires 220. The diameter of each metal wire 220 is set within a range of 0.1 to 0.6 mm. A particularly suitable diameter for the metal wires 220 is 0.15 mm. Each of the metal wires 220 includes the material for the metal film 92. A preferable example of the material for the metal film 92 is nickel. That is, each of the metal wires 220 is preferably made of nickel. However, there is no particular limitation thereto. Another example of the material for the metal film 92 is gold. In this case, each of the metal wires 220 is made of gold.

The support portion 218 supports the metal brush 216. In the present embodiment, the support portion 218 includes a pair of holding portions 222 and a shaft portion 224 fixed to the metal brush 216 via the pair of holding portions 222. The plurality of metal wires 220 are radially arranged about a portion supported by the support portion 218, i.e., with the portion supported by the support portion as the center. Thus, the appearance of the metal brush 216 is substantially cylindrical.

Each holding portion 222 has a disk shape in which an insertion hole is formed at the center. Each holding portion 222 is preferably formed from an elastically deformable material such as, for example, a thermoset elastomer (rubber) or a thermoplastic elastomer. The pair of holding portions 222 are disposed so as to sandwich the metal brush 216 from both sides in the axial direction thereof.

As shown in FIG. 10A, in the metal brush 216, it is preferable that the length of the metal wires 220 (hereinafter, also referred to as length L1 of the metal wires 220) protruding outward from the support portion 218 (holding portion 222) is 40.0 mm or less. In the present embodiment, the length L1 of the metal wires 220 is a length between the outer peripheral end surface of the holding portion 222 and the outer peripheral end surface of the metal brush 216 in the radial direction of the metal brush 216. The length L1 of the metal wires 220 is preferably 1.0 to 40.0 mm, and more preferably 3.0 to 9.0 mm.

In the metal brush 216, the thickness of a bundle of the plurality of metal wires 220 (hereinafter also referred to as thickness L2 of the metal brush 216) is preferably 3.0 to 15.0 mm. In the present embodiment, the thickness L2 of the metal brush 216 is a distance between the pair of holding portions 222 that sandwich the metal brush 216. The thickness L2 of the metal brush 216 is not particularly limited to the above-described ranges, and can be set in accordance with, for example, the size and shape of the film formation target portion and the size and shape of the workpiece W.

One end portion of the shaft portion 224 in the extending direction penetrates the metal brush 216 in an axial direction thereof via the insertion holes of the pair of holding portions 222. A locking screw 226 having a head portion with a larger diameter than the insertion hole of the holding portion 222 is fixed to the tip of the shaft portion 224 penetrating the pair of holding portions 222 and the metal brush 216. The head portion of the locking screw 226 abuts against the periphery of the insertion hole of one holding portion 222. At this time, a flange portion 228 provided on the shaft portion 224 comes into contact with the periphery of the insertion hole of the other holding portion 222. That is, the pair of holding portions 222 sandwiching the metal brush 216 is sandwiched between the head portion of the locking screw 226 and the flange portion 228. As a result, the metal brush 216, the pair of holding portions 222, and the shaft portion 224 are integrated.

The other end portion of the shaft portion 224 opposite to the one end portion provided with the metal brush 216 is fixed to, for example, the rotary main shaft 230. Thus, the metal brush 216 can be rotationally driven via the shaft portion 224.

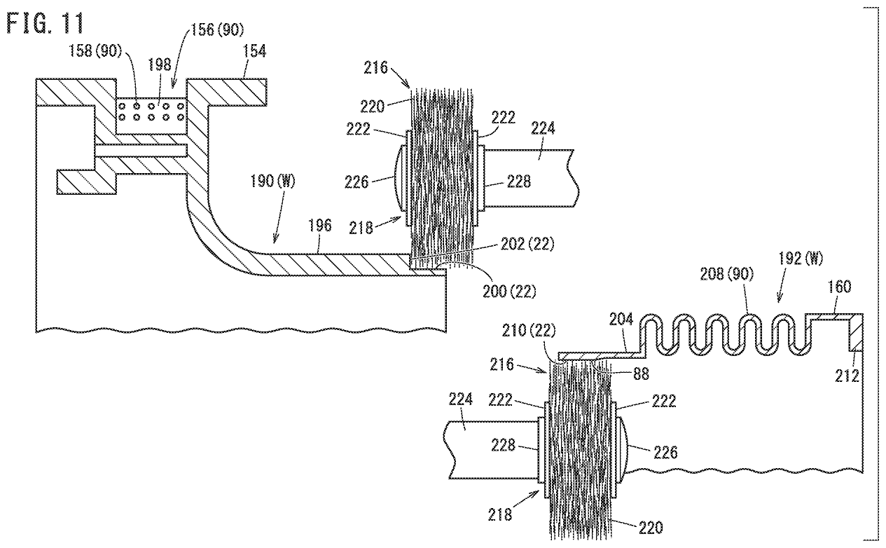

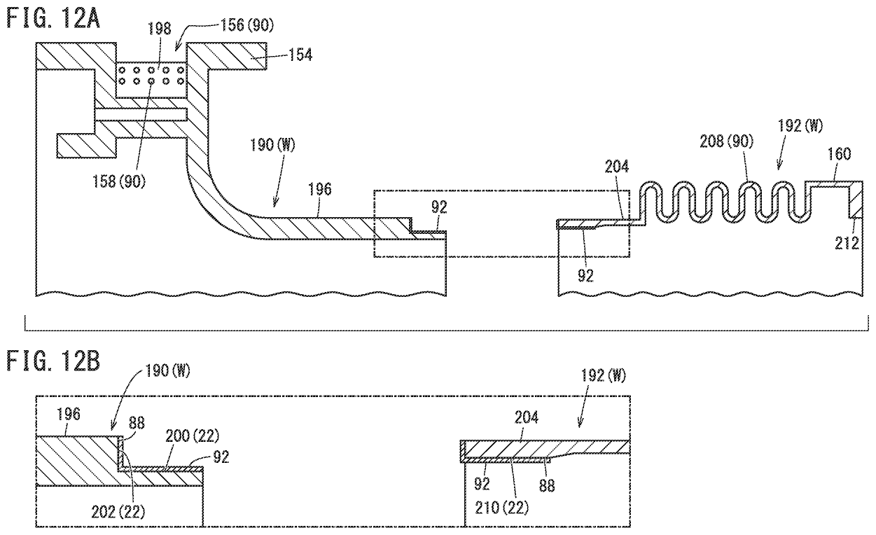

In the film formation step using the brazing metal film forming tool 214 configured as described above, as shown in FIG. 11, the film formation target portion (the joining target portions 22 and the brazing-material-allowed portions 88) and the metal brush 216 are relatively moved to each other in a state in which the metal brush 216 is brought into contact with the film formation target portion. Specifically, the peripheral surface of the metal brush 216 rotationally driven via the shaft portion 224 is brought into contact with the joining target portion 22. Thus, as shown in FIGS. 12A and 12B, the metal film 92 is formed on the film formation target portion.

In the film formation step, when the metal brush 216 brought into contact with the film formation target portion is rotationally driven, as described above, the metal brush 216 is held by the holding portions 222 formed of an elastically deformable material. As a result, each metal wire 220 of the metal brush 216 is protected, and thus, for example, the metal wires 220 can be prevented from breaking or bending. Consequently, the metal film 92 can be favorably formed on the film formation target portion. Further, the durability of the metal brush 216 can be improved.

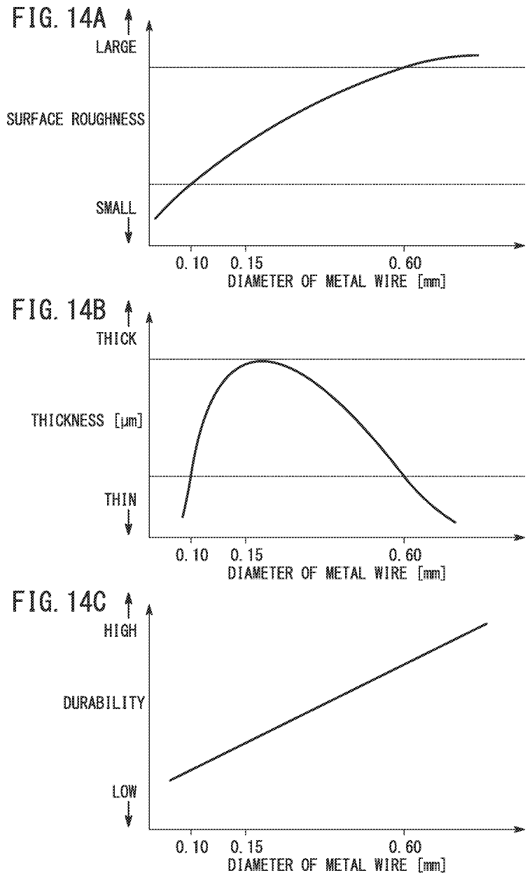

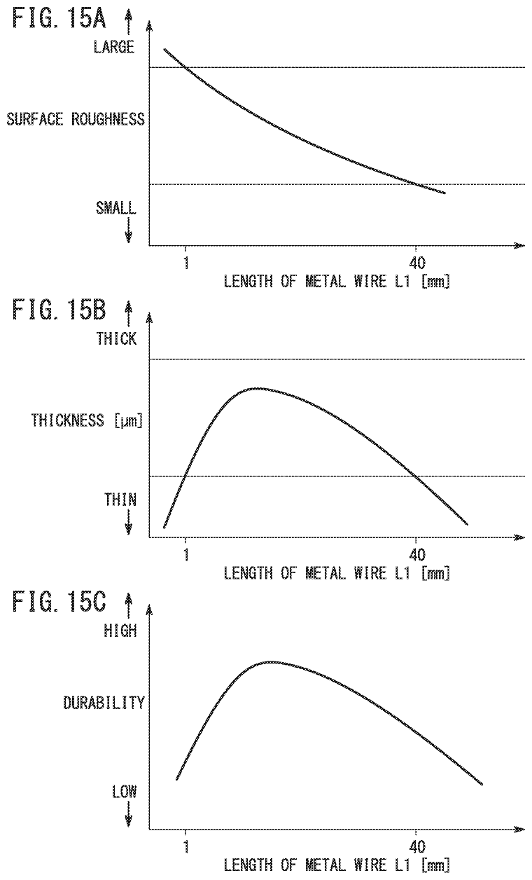

Here, as shown in FIG. 14A, it is found that there is a correlation between the diameter of the metal wires 220 and the degree of surface roughness (surface roughness) of the metal film 92 obtained in the film formation step. Further, as shown in FIG. 15A, it is found that there is a correlation between the length L1 of the metal wires 220 of the metal brush 216 and the degree of roughness (surface roughness) of the metal film 92 obtained in the film formation step.

As described above, by setting the diameter of the metal wires 220 within the range of 0.1 to 0.6 mm, the surface roughness of the obtained metal film 92 can be adjusted to a level suitable for brazing. To be specific, if the diameter of the metal wires 220 is smaller than 0.1 mm, when the metal wires 220 are brought into contact with the film formation target portion and relatively moved in the film formation step, the metal wires 220 are likely to be deformed more than necessary in a direction in which the metal wires 220 fall over. Therefore, the metal film 92 is formed while the peripheral surface (side surface) of the metal wires 220 is brought into contact mainly with the film formation target portion. As a result, it is considered that the surface roughness tends to be small.

In addition, when the diameter of the metal wires 220 exceeds 0.6 mm, the increase rate of the surface roughness with respect to the diameter is smaller than in a case where the diameter of the metal wires 220 is equal to or less than 0.6 mm. Therefore, by setting the diameter of the metal wires 220 within the range of 0.1 to 0.6 mm, it is possible to favorably form the metal film 92 having a surface roughness suitable for brazing.

Further, as described above, by setting the length L1 of the metal wires 220 of the metal brush 216 to 40.0 mm or less, it is possible to set the surface roughness of the obtained metal film 92 to a level suitable for brazing. To be more specific, if the length L1 of the metal wires 220 exceeds 40.0 mm, when the metal wires 220 are brought into contact with the film formation target portion and relatively moved in the film formation step, the metal wires 220 are likely to be deformed more than necessary in a direction in which the metal wires 220 fall over. Therefore, the metal film 92 is formed while the peripheral surface (side surface) of the metal wires 220 is brought into contact mainly with the film formation target portion. As a result, it is considered that the surface roughness tends to be small.

Therefore, by setting the length L1 of the metal wires 220 to 40.0 mm or less, it is possible to favorably form the metal film 92 having a surface roughness suitable for brazing. For example, the metal film 92 having an uneven surface (stepped surface) with a height difference of 1 to 15 μm can be obtained by the film formation step. Accordingly, the capillary action is promoted, and the wettability of the film formation target portion with respect to the brazing material 94 can be favorably enhanced.

In the metal brush 216, since formation of the metal film 92 on the film formation target portion causes consumption of the metal wires 220, the length L1 of the metal wires 220 is shortened. In the brazing metal film forming tool 214, it is preferable that, when the length L1 reaches 1 mm (more preferably 3.0 mm) as a result of consumption of the metal wires 220, the metal brush 216 should be replaced with a new metal brush 216 having metal wires 220 whose length L1 is 40.0 mm or less.

As shown in FIG. 14B, it is found that there is a correlation between the diameter of the metal wires 220 and the thickness (film thickness) of the metal film 92 obtained in the film formation step. Further, as shown in FIG. 15B, it is found that there is a correlation between the length L1 of the metal wires 220 of the metal brush 216 and the thickness (film thickness) of the metal film 92 obtained in the film formation step.

The thickness of the metal film 92 can also be adjusted, for example, by adjusting the pressure, processing time, and the like when the metal brush 216 is brought into contact with the film formation target portion. At this time, as described above, by setting the diameter of the metal wires 220 within the range of 0.1 to 0.6 mm, the obtained metal film 92 can easily have a thickness suitable for brazing. In addition, as described above, by setting the length L1 of the metal wires 220 of the metal brush 216 to 40.0 mm or less, the obtained metal film 92 can easily have a thickness suitable for brazing.

In a case where the diameter of the metal wires 220 exceeds 0.6 mm, when the metal wires 220 are brought into contact with the film formation target portion and relatively moved in the film formation step, the amount of deformation in the direction in which the metal wires 220 fall over tends to be insufficient. For this reason, it is considered that the contact area between the metal wires 220 and the film formation target portion is small, and the thickness of the metal film 92 is likely to be thin.

In a case where the diameter of the metal wires 220 is less than 0.1 mm, when the metal wires 220 are brought into contact with the film formation target portion and relatively moved in the film formation step, the metal wires 220 are likely to be deformed more than necessary in a direction in which the metal wires 220 fall over. In this case, it is considered that it is difficult to press the metal wires 220 against the film formation target portion and that the metal wires 220 are likely to be broken. As a result, it is considered that the thickness of the metal film 92 tends to be thin. Therefore, by setting the diameter of the metal wires 220 within the range of 0.1 to 0.6 mm, it is possible to favorably form the metal film 92 having a thickness suitable for brazing.

If the length L1 of the metal wires 220 exceeds 40.0 mm, when the metal wires 220 are brought into contact with the film formation target portion and relatively moved in the film formation step, the metal wires 220 are likely to be deformed more than necessary in a direction in which the metal wires 220 fall over. Therefore, as described above, it is considered that the thickness of the metal film 92 is likely to be thin. Therefore, by setting the length L1 of the metal wires 220 to 40.0 mm or less, it is possible to favorably form the metal film 92 having a thickness suitable for brazing.

The thickness of the metal film 92 suitable for brazing is preferably 1 to 30 μm, for example. It is more preferably 2.5 to 25 μm. Brazing can be suitably performed with the metal film 92 having such a thickness, but a more suitable thickness of the metal film 92 is 17 to 19 μm. By setting the thickness of the metal film 92 within a range of 17 to 19 μm, it is possible to satisfactorily spread the melted brazing material 94 over the entire joining target portion 22 and the brazing-material-allowed portion 88.

As shown in FIG. 14C, it is found that there is a correlation between the diameter of the metal wires 220 and the durability of the metal brush 216. Further, as shown in FIG. 15C, it is found that there is a correlation between the length L1 of the metal wires 220 of the metal brush 216 and the durability of the metal brush 216. Here, the durability of the metal brush 216 refers to, for example, resistance to breaking or bending (difficulty in breaking or bending).

As the diameter of each metal wire 220 is larger, the metal wires 220 are less likely to be broken or bent, and the durability of the metal brush 216 can be increased. Therefore, as described above, it is preferable to increase the diameter of the metal wires 220 within a range in which the surface roughness and the thickness of the metal film 92 can be set to values suitable for brazing.

In addition, as described above, by setting the length L1 of the metal wires 220 of the metal brush 216 to 40.0 mm or less, it is possible to prevent the metal wires 220 from being deformed more than necessary in the falling direction in the film formation step as described above. As a result, the durability of the metal brush 216 can be enhanced.

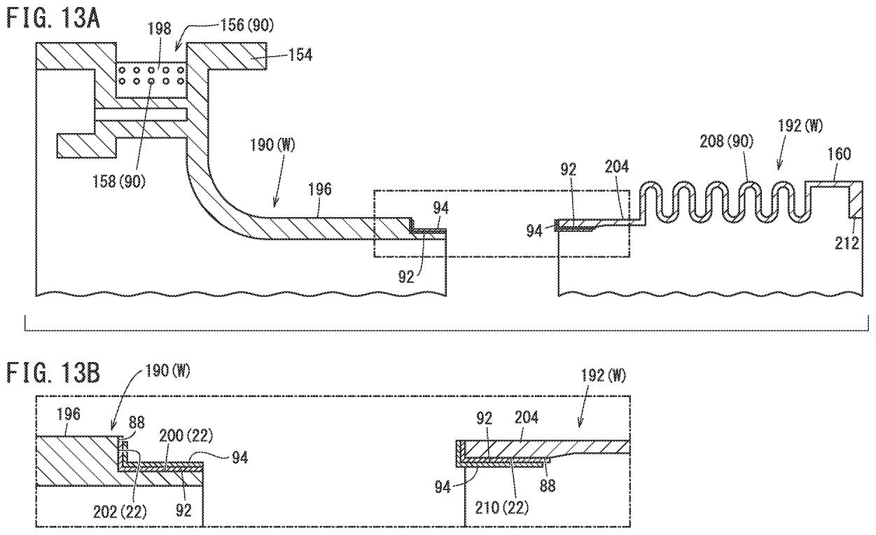

In the brazing method using the brazing metal film forming tool 214, the brazing step is performed after the pretreatment for forming the metal film 92 is performed in the film formation step as described above. The brazing step includes a brazing preparation step of applying the brazing material 94 to the joining target portions 22, and a heat treatment step of melting the brazing material 94. As shown in FIGS. 13A and 13B, after the above-described pretreatment, the brazing material 94 is applied to at least one of the pair of joining target portions 22, thereby completing the brazing preparation step. In the present embodiment, the brazing material 94 is applied to both of the pair of joining target portions 22. At this time, the brazing material 94 may not be applied to the brazing-material-allowed portion 88, or the brazing material 94 may also be applied to the brazing-material-allowed portion 88, in addition to the joining target portions 22. Examples of the material for the brazing material 94 include, but are not limited to, nickel, gold, silver, copper, and cobalt.

Then, as shown in FIGS. 8 and 9, the pair of joining target portions 22 between which the brazing material 94 is provided are subjected to heat treatment in a heat treatment furnace. Thus, the pair of joining target portions 22 are joined together in a state in which the brazing material 94 is disposed on the joining target portions 22 and the brazing-material-allowed portions 88, and the heat treatment step is completed. The brazing material 94 disposed in the brazing-material-allowed portion 88 is melted in the heat treatment furnace and then solidified, whereby the fillet 96 is formed on the brazing-material-allowed portion 88. As a result, at the fourth joint 194, the inflow-side member 190 and the discharge-side member 192 are integrated by brazing to obtain the nozzle 16.

As described above, in the metal film forming tool for brazing 214 according to the present embodiment, the metal film 92 can be formed on the film formation target portion by relatively moving the metal brush 216 relative to the film formation target portion while being in contact with the film formation target portion. Therefore, for example, unlike a case where a metal film is formed by electroplating, a step of masking the avoidance portion 90 is not necessary. As a result, it is possible to improve the joining quality of the joint by providing the metal film on the joining target portion 22 and also to efficiently and easily perform brazing.

In a case where the metal film 92 is formed using the brazing metal film forming tool 214, for example, compared to a case where a metal film is formed by electroplating, a metal film can be easily formed even on a film formation target portion having a small area. Therefore, even in the case of the workpiece W having a complicated shape, the formation of the metal film 92 on the avoidance portion 90 can be avoided with high accuracy, and the metal film 92 can be formed on both the joining target portion 22 and the brazing-material-allowed portion 88 in a pinpoint manner.

As a result, it is possible to effectively prevent the avoidance portion 90 from being affected by the metal film 92. In addition, the pair of joining target portions 22 can be joined to each other with the metal films 92 being formed highly precisely on the joining target portions 22 and the brazing-material-allowed portions 88, and the brazing material 94 being disposed thereon. Thus, it is possible to further improve the joining quality of brazing. Furthermore, the metal films 92 are not formed on portions other than the joining target portions 22 or the brazing-material-allowed portions 88, and accordingly wasteful use of the metal films 92 can be reduced. As a result, the cost required for brazing can be effectively reduced.

The metal film 92 formed using the brazing metal film forming tool 214 has an uneven surface (stepped surface) as described above, and has a larger surface roughness (degree of surface roughness) than the metal film 92 formed by electroplating, for example. Therefore, by forming the metal film 92 on the film formation target portion using the brazing metal film forming tool 214, it is possible to cause a capillary action between the concavity and the convexity of the metal film 92. In this case, it is possible to promote melting and flowing of the brazing material 94 continuously occurring on the surface of the metal film 92. Therefore, also owing to this, it is possible to satisfactorily spread the brazing material 94 on the metal film 92 and to improve the joining quality between the joining target portions 22. In addition, since the fillet 96 can be favorably formed on the brazing-material-allowed portion 88, it is possible to easily check whether brazing has been favorably performed.

In the brazing method according to the above-described embodiment, the avoidance portion 90 has at least one selected from: a portion where an opening through which a fluid can flow is formed; a portion, of the surface of the workpiece W, that is coated with a coating layer; and a portion where an uneven portion is formed.

In a case where the avoidance portion 90 is a portion in which an opening is formed, masking on the avoidance portion 90 is not necessary, and thus, for example, a masking material does not remain in the opening. In addition, it is possible to avoid formation of the metal film 92 on the avoidance portion 90. Accordingly, it is possible to effectively prevent the flow of the fluid from being blocked by the masking material and the metal film 92.

When the avoidance portion 90 is a portion coated with a coating layer, the formation of the masking material and the metal film 92 on the coating layer can be avoided. Therefore, for example, the masking material and the metal film 92 can be prevented from being peeled off and falling off the coating layer.

When the avoidance portion 90 is a portion where an uneven portion is formed, it is possible to prevent the masking material from remaining in the uneven portion. In addition, it is possible to prevent the metal film 92 from being formed on the uneven portion. For this reason, it is possible to prevent the concavity of the uneven portion from being occluded by the masking material and the metal film 92, and to prevent the masking material and the metal film 92 from peeling off and falling off from the surface of the uneven portion.

Therefore, when the avoidance portion 90 has at least one selected from a group of a portion in which an opening through which a fluid can flow is formed, a portion of the surface of the workpiece W that is coated with a coating layer, and a portion in which an uneven portion is formed, the brazing method according to the present embodiment can be more suitably applied.

In the brazing method according to the above-described embodiment, the material for the metal film 92 is nickel, and the workpiece W is made of a heat-resistant alloy. The heat-resistant alloy generally tends to have low wettability with respect to the brazing material 94. Therefore, by applying the brazing method to form the metal film 92 made of nickel on the workpiece W that is a heat-resistant alloy, it is possible to effectively improve the wettability of the joining target portions 22 and the brazing-material-allowed portions 88 with respect to the brazing material 94. As a result, it is possible to satisfactorily spread the brazing material 94 over the joining target portions 22 and the brazing-material-allowed portions 88, and to effectively improve the joining quality of the joint.

In the brazing method according to the above embodiment, the heat-resistant alloy is selected from a nickel-based alloy containing either titanium or aluminum, an iron-based alloy containing either titanium or aluminum, a nickel-based alloy containing both titanium and aluminum, and an iron-based alloy containing both titanium and aluminum. In a case where either titanium or aluminum is included in the heat-resistant alloy forming the workpiece W, there is a concern that at least one of titanium and aluminum diffuses to the brazing surface and brazing is inhibited. As such, by applying the brazing method according to the present embodiment to form the metal film 92, it is possible to suppress diffusion of at least one of titanium and aluminum to the brazing surface. This makes it possible to effectively improve the joining quality of the joint.

Examples of the nickel-based alloys containing one or both of titanium and aluminum include Inconel 625, Inconel 718 (both of which are trade names of Inco Limited), and MAR-M247. Examples of the iron-based alloys containing one or both of titanium and aluminum include maraging steel and A286.

In the metal brush 216 of the metal film forming tool for brazing 214 according to the above-described embodiment, the length L1 of portions of the metal wires 220 that protrude outward from the support portion 218 is 40.0 mm or less. In this case, as described above, it is possible to easily form the metal film 92 having a surface roughness and a thickness suitable for brazing. Further, the durability of the metal brush 216 can be improved.

In the metal brush 216 of the metal film forming tool for brazing 214 according to the above-described embodiment, the thickness L2 of the bundle of the metal wires 220 is 3.0 to 15.0 mm. In this case, for example, even in the case of a film formation target portion having a relatively small area or a film formation target portion having a complicated shape, the metal brush 216 can be brought into good contact with the film formation target portion and can be relatively moved. As a result, the metal film 92 can be favorably formed.

In the metal film forming tool for brazing 214 according to the above-described embodiment, the metal wires 220 are made of nickel. In this case, the metal film 92 made of nickel can be formed by the metal film forming tool for brazing 214. As a result, it is possible to effectively improve the wettability of the joining target portion 22 and the brazing-material-allowed portion 88 with respect to the brazing material 94. As a result, it is possible to satisfactorily spread the brazing material 94 over the joining target portions 22 and the brazing-material-allowed portions 88, and to effectively improve the joining quality of the joint. In addition, by forming the metal wires 220 from nickel, it is possible to reduce the cost for forming the metal film 92, compared to a case of forming the metal film 92 from gold by using the metal wires 220 made of gold, for example.

On the other hand, the material for the metal wires 220 is not limited to nickel or gold. The material for the metal wires 220 can also be appropriately selected in accordance with the material for the brazing material 94. For example, when at least one selected from nickel, silver, and copper is used as the material for the brazing material 94, nickel can be used as the material for the metal wires 220. When gold is used as the material for the brazing material 94, nickel or gold can be used as the material for the metal wires 220.

In the metal film forming tool for brazing 214 according to the above-described embodiment, the plurality of metal wires 220 are radially arranged with the portion supported by the support portion 218 as the center, so that the metal brush 216 has a cylindrical shape, the support portion 218 includes the shaft portion 224 passing through the center and extending in the axial direction of the metal brush 216, and the metal brush 216 is rotationally driven via the shaft portion 224, so that the peripheral surface of the rotating metal brush 216 can come into contact with the joining target portion 22. In this case, with a simple configuration in which the peripheral surface of the metal brush 216 is brought into contact with the joining target portion 22 while the metal brush 216 is being rotated, it is possible to favorably form the metal film 92 on the film formation target portion.

The present invention is not limited to the above-described embodiment, and various configurations can be adopted without departing from the essence and gist of the present invention.

For example, in the above-described embodiment, the external shape of the metal brush 216 is a cylindrical shape, but the external shape is not particularly limited thereto. The metal brush 216 may be formed by bundling a plurality of metal wires 220 such that the axial directions thereof are substantially parallel to each other.

In the above-described embodiment, the peripheral surface of the metal brush 216 rotationally driven via the shaft portion 224 is brought into contact with the film formation target portion. However, it is sufficient to relatively move the metal brush 216 relative to the film formation target portion with the metal brush 216 being in contact with the film formation target portion, and the present invention is not limited to rotating the metal brush 216. For example, the metal brush 216 may be moved linearly relative to the film formation target portion.

What is claimed is:

1. A brazing method for forming a metal film on at least one of a pair of joining target portions included in a pair of workpieces and thereafter brazing the pair of joining target portions to each other, wherein
of the pair of workpieces, a workpiece on which the metal film is to be formed includes a brazing-material-allowed portion adjacent to one joining target portion of the pair of joining target portions, and an avoidance portion on which formation of the metal film is not allowed,
the brazing method comprising:
a film formation step of forming the metal film on a film formation target portion by moving a metal brush relative to the film formation target portion with the metal brush being in contact with the film formation target portion, wherein the film formation target portion includes the one joining target portion and the brazing-material-allowed portion but does not include the avoidance portion, and the metal brush is formed by bundling a plurality of metal wires including a material for the metal film; and
a brazing step of applying a brazing material to at least one of the pair of joining target portions and performing heat treatment on the pair of joining target portions between which the brazing material is provided, thereby joining the pair of joining target portions in a state where the brazing material is disposed on the pair of joining target portions and the brazing-material-allowed portion.

2. The brazing method according to claim 1, wherein
the avoidance portion includes at least one selected from:
a portion where an opening that allows a fluid to flow therethrough is formed; a portion, of a surface of the workpiece, that is coated with a coating layer; and a portion where an uneven portion is formed.

3. The brazing method according to claim 1, wherein
the material for the metal film is nickel, and
the workpieces are made of a heat-resistant alloy.

4. The brazing method according to claim 3, wherein
the heat-resistant alloy is selected from: a nickel-based alloy containing either titanium or aluminum; an iron-based alloy containing either titanium or aluminum; a nickel-based alloy containing both of titanium and aluminum; and an iron-based alloy containing both of titanium and aluminum.

5. A metal film forming tool for brazing, for forming a metal film on at least one of a pair of joining target portions included in a pair of workpieces, before brazing the joining target portions to each other, the metal film forming tool for brazing comprising:
a metal brush configured to form the metal film on the joining target portion by moving relative to the joining target portion in a state of being in contact with the joining target portion; and
a support portion configured to support the metal brush,
wherein the metal brush has a brush shape formed by bundling a plurality of metal wires, and
each of the plurality of metal wires has a diameter of 0.1 to 0.6 mm.

6. The metal film forming tool for brazing, according to claim 5, wherein
a length of portions of the plurality of metal wires that protrude outward from the support portion is 40.0 mm or less.

7. The metal film forming tool for brazing, according to claim 5, wherein
in the metal brush, a thickness of the bundled plurality of metal wires is 3.0 to 15.0 mm.

8. The metal film forming tool for brazing, according to claim 5, wherein
the metal wires are made of nickel.

9. The metal film forming tool for brazing, according to claim 5, wherein
the plurality of metal wires are radially arranged with a portion supported by the support portion as a center, so that the metal brush has a cylindrical shape,
the support portion includes a shaft portion that passes through the center and extends in an axial direction of the metal brush, and
when the metal brush is rotationally driven via the shaft portion, a peripheral surface of the rotating metal brush is configured to be brought into contact with the one joining target portion.
